(19) United States
(12) Patent Application Publication
(10) Pub. No.: US 2006/0109350 A1
(43) Pub. Date: May 25, 2006

(54) Glasses type audio-visual recording apparatus

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/995,385

(22) Filed: Nov. 24, 2004

(51) Int. Cl. H04N 5/225

(52) U.S. Cl. 348/207.99

(57) ABSTRACT

A glasses type audio-visual recording apparatus is disclosed. The glasses type audio-visual recording apparatus mainly comprises a pair of glasses and an audio-visual recording apparatus mounted on a distal end of a frame of the glasses so as to integrate the glasses and the audio-visual recording apparatus into unity. Consequently, user is able to readily listen to digital music stored in the audio-visual recording apparatus by wearing the glasses such that the audio-visual recording apparatus is closest to the ear. The problem caused by the winding earphone wires is thus prevented.

### FIELD OF THE INVENTION

The present invention relates to a glasses type audio-visual recording apparatus that provides the capability of synchronously utilizing the glasses and the audio-visual recording apparatus and shortening the distance between the audio-visual recording apparatus and the ear for preventing from the problem caused by the winding earphone wires. The glasses type audio-visual recording apparatus is suitable for a voice player or the like for listening to digital music.

### BACKGROUND OF THE INVENTION

Due to long time use of eye or poor posture in study, many modern persons suffer from nearsightedness. This phenomenon brings about close relationship between glasses and people so the glasses become requisites of daily life. During the commute time, it can be seen that many travelers in the public transportation utilize Walkman to achieve the purposes of learning and entertainment. Tape Walkman and CD Walkman are previously utilized. However, users always complain that tapes or compact discs of these two kinds of Walkmans have to be replaced, and they are large and heavy.

Besides, as regards a common monitoring apparatus, a fixed camera is generally disposed on an entrance so as to capture facial images of incoming and/or outgoing persons. However, since the monitoring apparatus is immobile and the camera is very large and expensive, a person who has a mind to do something bad can avoid being captured by the camera.

A new generation of Walkman, i.e. voice player, has been made in view of the drawbacks of the aforementioned structure. Since the voice player has smaller size and lighter weight, users have no need to change compact discs or tapes. Therefore, the voice player is widely adopted by young people. It can be seen that almost every day student carries one voice player by using a necklace to hang the voice player on the neck so as to listen to the digital music or voice stored in the voice player through a wired earphone. However, interference from the earphone wires of the wired earphone still cannot be avoided even through this voice player has been improved some drawbacks of the conventional Walkman.

In view of the aforementioned drawbacks of the conventional structure, the present inventor has been made diligent studies with a quiet mind to provide a glasses type audio-visual recording apparatus that integrates daily supplies, learning articles, and recreation articles with one another. This glasses type audio-visual recording apparatus is provided for the public in accordance with motivations of the present invention.

### SUMMARY OF THE INVENTION

The main purpose of the present invention is to provide a combined audio-visual recording apparatus and glasses, which enables the user to carry the audio-visual recording apparatus when he wears the glasses. Besides, the audio-visual recording apparatus is mounted on a position where is closest to the ear so as to prevent the user from the winding earphone wires.

Another purpose of the present invention is to utilize the semiconductor packaging technique to provide the audio-visual recording apparatus with the capability of monitoring.

In order to achieve the aforementioned purposes, the present invention provides a glasses type audio-visual recording apparatus, which mainly comprises a pair of glasses and an audio-visual recording apparatus mounted on an upper edge of a pair of lenses of the glasses so as to integrate the glasses and the audio-visual recording apparatus into unity, wherein an earphone is embedded in a distal end of a frame of the glasses. Consequently, user is able to readily listen to digital music stored in the audio-visual recording apparatus by wearing the glasses. The problem caused by the winding earphone wires is thus prevented.

The other features and preferred embodiments of the present invention will now be described with reference to the accompanying drawings.

### BRIEF DESCRIPTION OF THE DRAWINGS

FIG. 1A is a perspective view showing an appearance of a first preferred embodiment of the present invention.

Fig. lB is a perspective view showing another application example of a first preferred embodiment of the present invention.

FIG. 2 is an exploded view showing devices of a second preferred embodiment of the present invention.

FIG. 3 is a perspective view showing an appearance of a third preferred embodiment of the present invention.

FIG. 4 is a schematic view showing the use of the preferred embodiments of the present invention.

### DETAILED DESCRIPTION OF THE PREFERRED EMBODIMENT

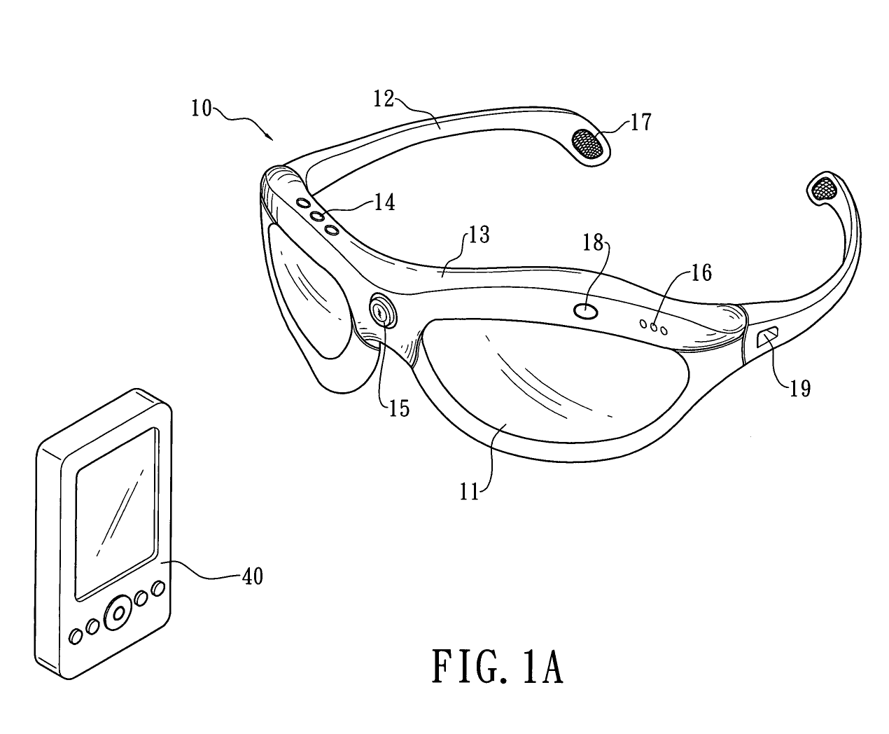

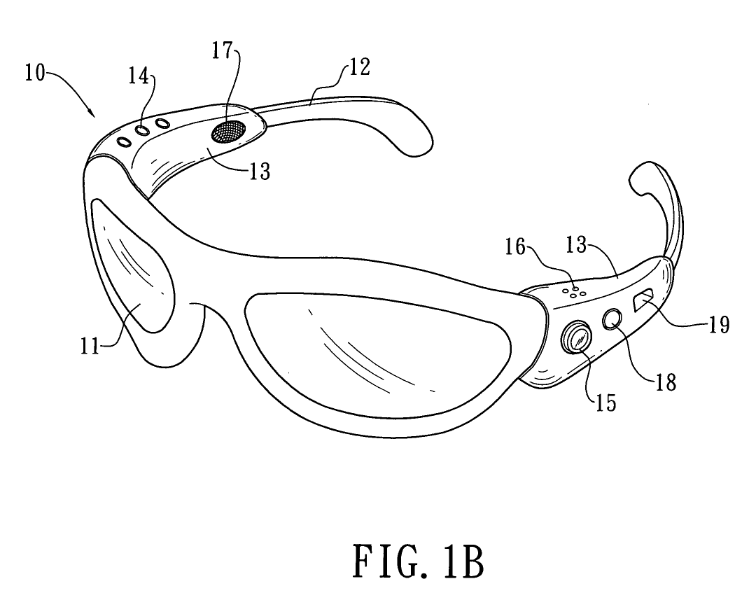

Referring to FIG. 1A, a glasses type audio-visual recording apparatus of the present invention with a pair of glasses 10 is shown. An audio-visual recording apparatus 13 is mounted on upper edges of a pair of lenses 11 of the glasses 10. The audio-visual recording apparatus 13 comprises a plurality of function buttons 14, a camera 15, an identifier 18, a USB connector 19, and a microphone 16. A hidden earphone or speaker 17 is mounted respectively on two distal ends of a frame 12 of the glasses 10. Besides, a Bluetooth chip and an auto-switch are mounted inside the audio-visual recording apparatus 13. Moreover, the audio-visual recording apparatus 13 and the glasses 10 are molded into unity. An alternative structure for achieving the same purpose of synchronous use is to mount the audio-visual recording apparatus 13 respectively on both sides of the frame 12 of the glasses 10, as shown in FIG. 1B.

Therefore, if a user wears on the glasses 10 for doing routine work, then it means that he also carries the audio-visual recording apparatus 13. When this user desires to listen to music, he just needs to switch on the audio-visual recording apparatus 13 and press the function buttons 14. Thereafter, the user can displace the audio-visual recording apparatus 13 on a position close to his ears for listening to the music through the hidden speakers 17 mounted on the distal ends of the frame 12 so as to avoid limitation caused by conventional earphone wires. Moreover, the camera 15 and the microphone 16 can be utilized to make a video and/or audio recording.

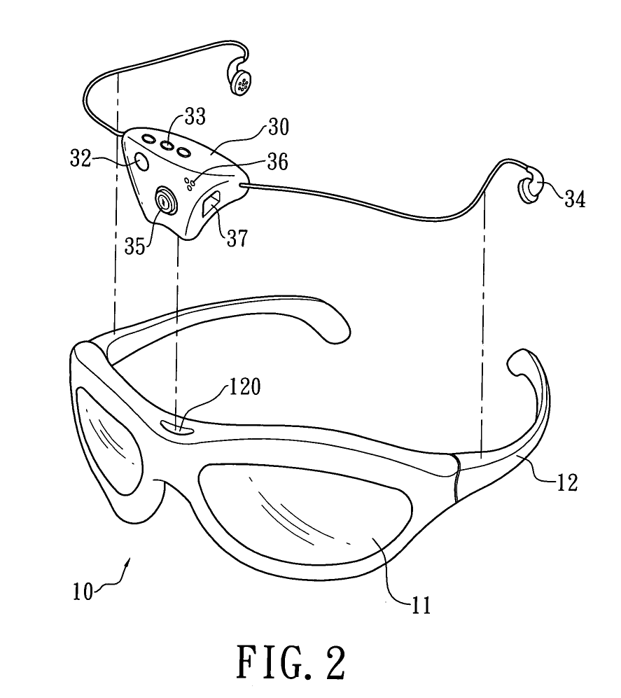

Please refer to FIG. 2, which shows a separable type of combined glasses and audio-visual recording apparatus in accordance with a second embodiment of the present invention. The second preferred embodiment of the present invention comprises a pair of glasses 10 and an audio-visual recording apparatus 30. The glasses 10 comprise a pair of lenses 11 and a frame 12, wherein a connection trench 120 is mounted on a central portion of an upper edge of the frame 12. The audio-visual recording apparatus 30 comprises a connection part (not shown) corresponding to the connection trench 120 of the glasses 10. Moreover, the audio-visual recording apparatus 30 also comprises a monitor (not shown), a plurality of function buttons 33, an identifier 32, a camera 35, a microphone 36, a USB connector 37, and two earphones 34. Furthermore, a Bluetooth chip and an auto-switch are mounted inside the audio-visual recording apparatus 30.

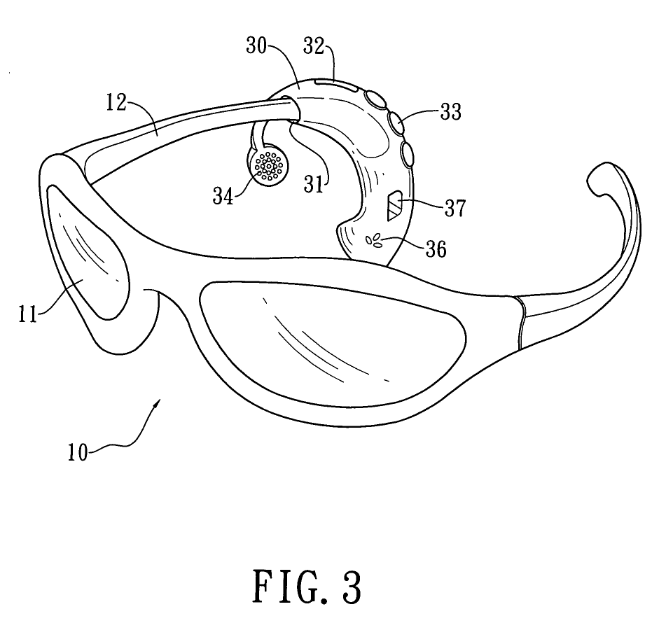

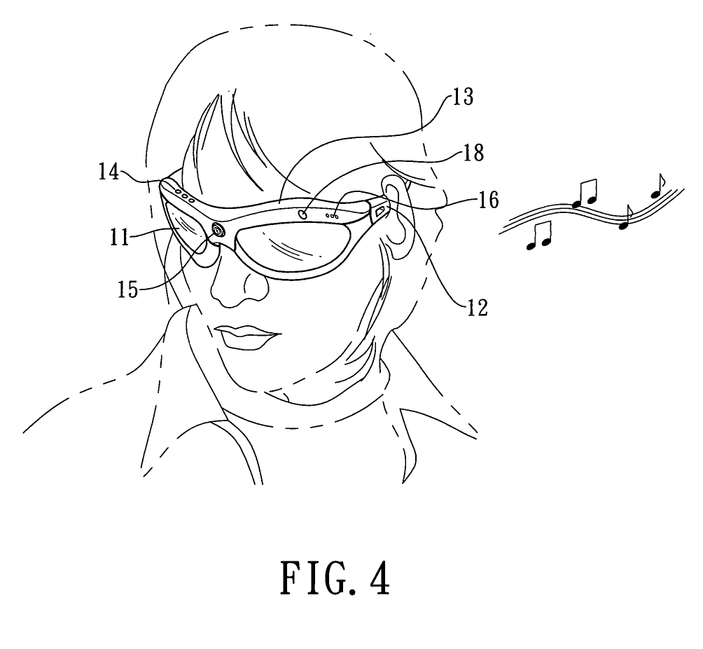

Please refer to FIG. 3, which shows a separable type of combined glasses and audio-visual recording apparatus in accordance with a third embodiment of the present invention. The second preferred embodiment of the present invention comprises a pair of glasses 10 and an audio-visual recording apparatus 30. The glasses 10 also comprise lenses 11 and a frame 12, wherein the audio-visual recording apparatus 30 that hands on the ear belongs to an ear-fit type. Moreover, an earphone 34 is mounted on one end of the audio-visual recording apparatus 30. A connection part 31 is mounted in a proper position of an upper end of the audio-visual recording apparatus 30. A microphone 36 is mounted on a lower end of the audio-visual recording apparatus 30. Moreover, a plurality of function buttons 33, a USB connector 37, and an identifier 32 is mounted on the periphery of the audio-visual recording apparatus 30. Furthermore, a Bluetooth chip and an auto-switch are mounted inside the audio-visual recording apparatus 30.

For the purpose of use, the frame 12 of the glasses 10 is coupled with the connection part 31 of the audio-visual recording apparatus 30 so as to integrate the glasses 10 and the audio-visual recording apparatus 30 into unity. Therefore, if user wants to listen to music and utilize the glasses 10 synchronously, then he just needs to wear the glasses 10 so as to hang the audio-visual recording apparatus 30 on the ear and plug the earphone 34 into the earhole. The problem caused by the winding earphone wires is thus prevented.

Furthermore, no matter the combined glasses and audio-visual recording apparatus belongs to an immobile type or a separable type, the identifier 18/32 mounted inside the audio-visual recording apparatus 13/30 is a radio frequency identification (RFID) system, wherein a card reader is used for reading the RFID code stored in the identifier so as to achieve the purpose of entrance control. Besides, the audio-visual recording apparatus 13/30 may further comprise a memory card slot for receiving a memory card.

Moreover, the audio-visual recording apparatus 13/30 comprises a USB connector 19/37 or a wireless transmission device (not shown) that is capable of connecting to a computer. Besides, the camera 15 further cooperates with a palm-size monitor 40, wherein the captured data are transmitted to the palm-size monitor 40 through the wireless transmission device to facilitate the user to watch the data immediately, or a projection method may be utilized directly to project images to the lenses. In addition, a thin-film LCD eyeshade may be utilized to achieve the purpose of watching the captured data immediately. Therefore, if the user desires to watch the captured images, it is not necessary for him to come back to the room where the computer mounts and take off the glasses 10 for connecting the glasses 10 with the computer. In addition, the palm-size monitor 40 comprises a position system selected from a group consisting of GPS, CDMA, GSM, and PHS for providing the audio-visual recording apparatus with an advanced tracking function.

The present invention can be applied to monitor the statuses of military personnel, policemen, or security guards at any moment when they are on duty. Besides, because of the Bluetooth chip mounted inside the audio-visual recording apparatus 13/30, the state of listening to music can be switched automatically into the state of answering the phone if there is an incoming call for the user who carries a mobile phone. Therefore, the user has no need to stop the work that is proceeding for looking for the mobile phone for answering the phone.

As described above, it is apparent that the apparatus of the present invention comprises the following advantages.

1. The audio-visual recording apparatus and the glasses are integrated into unity so as to enable the user to carry the audio-visual recording apparatus when he wears the glasses. Besides, the audio-visual recording apparatus is mounted in a position where is closest to the ear so as to prevent the user from the winding earphone wires.

2. The present invention significantly promotes the ability to monitor the statuses of military personnel, policemen, or security guards at any moment when they are on duty.

3. Because of the Bluetooth chip mounted inside the audio-visual recording apparatus, the user is able to answer the phone without stopping the work that is proceeding if there is an incoming call for the user who carries the mobile phone.

4. The size of the audio-visual recording apparatus is reduced by using the semiconductor packaging technique for combining the audio-visual recording apparatus with the glasses so as to avoid interfering with glasses wearing.

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention is able to achieve the expected purpose of the present invention by providing a glasses type audio-visual recording apparatus. The application that complies with utility is therefore submitted for a patent.

What the invention claimed is:

1. A glasses type audio-visual recording apparatus comprising:
a pair of glasses having a pair of lenses and a frame, an audio-visual recording apparatus being mounted on an upper edge of said lenses, a plurality of function buttons, a camera, an identifier, a USB connector, and a microphone being mounted on said audio-visual recording apparatus, a hidden earphone being mounted on a distal end of the frame of said glasses, a Bluetooth chip, an auto-switch, and a wireless transmission device being mounted inside said audio-visual recording apparatus.

2. The glasses type audio-visual recording apparatus of claim 1, further comprising a hidden speaker mounted on said distal end of said frame.

3. The glasses type audio-visual recording apparatus of claim 1, wherein said audio-visual recording apparatus further cooperates with a palm-size monitor.

4. The glasses type audio-visual recording apparatus of claim 3, wherein said palm-size monitor comprises a position system selecting from a group consisted of GPS, CDMA, GSM, and PHS.

5. The glasses type audio-visual recording apparatus of claim 1, wherein said audio-visual recording apparatus further comprises a memory card slot.

6. The glasses type audio-visual recording apparatus of claim 1, wherein said audio-visual recording apparatus utilizes a projection method to project images to said lenses for displaying thereof.

7. The glasses type audio-visual recording apparatus of claim 1, wherein said audio-visual recording apparatus utilizes a thin-film LCD eyeshade to display images.

8. A glasses type audio-visual recording apparatus comprising:
a pair of glasses having a pair of lenses and a frame; and
an audio-visual recording apparatus having a connection part for connecting with said glasses, a plurality of function buttons, an identifier, a camera, and a microphone being mounted on said audio-visual recording apparatus, a Bluetooth chip, an auto-switch, and a wireless transmission device being mounted inside said audio-visual recording apparatus.

9. The glasses type audio-visual recording apparatus of claim 8, further comprising an earphone mounted on an upper edge of said glasses.

10. The glasses type audio-visual recording apparatus of claim 8, wherein said connection part is mounted on a lower edge of said audio-visual recording apparatus for connecting with an upper edge of said lenses of said glasses.

11. The glasses type audio-visual recording apparatus of claim 8, wherein said audio-visual recording apparatus cooperates with a palm-size monitor.

12. The glasses type audio-visual recording apparatus of claim 8, wherein said audio-visual recording apparatus belongs to an ear-fit type, and an earphone and the connection part are mounted respectively on one end and a central portion of said audio-visual recording apparatus.

13. The glasses type audio-visual recording apparatus of claim 8, wherein said audio-visual recording apparatus further comprises a memory card slot.

14. The glasses type audio-visual recording apparatus of claim 8, wherein said audio-visual recording apparatus utilizes a projection method to project images to said lenses for displaying thereof.

15. The glasses type audio-visual recording apparatus of claim 8, wherein said audio-visual recording apparatus utilizes a thin-film LCD eyeshade to display images.
